(19) United States
(12) Patent Application Publication
(10) Pub. No.: US 2005/0098935 A1
(43) Pub. Date: May 12, 2005

(54) Book production apparatus and method for producing books

(76) Inventors: Michael Sittinger, Lombard, IL (US); Robert Stolz, Downers Grove, IL (US); Riyazhassan M. Azaria, Oak Park, IL (US); Steve Martinich, Naperville, IL (US)

Correspondence Address: MCCRACKEN & FRANK LLP, 200 W. ADAMS STREET, SUITE 2150, CHICAGO, IL, 60606, US

(21) Appl. No.: 10/706,065

(22) Filed: Nov. 12, 2003

(51) Int. Cl. B41L 43/00

(52) U.S. Cl. 270/32

(57) ABSTRACT

A book production apparatus includes a gathering line operable during a production sequence and a demand printer for producing printed pages. The book production apparatus further includes a feeding device operable to feed the printed pages to the gathering line and a controller that coordinates operation of the gathering line, the demand printer, and the feeding device during the production sequence to produce books.

### TECHNICAL FIELD

The present invention relates generally to a gathering line for producing books, or other printed materials, and, more specifically, to a gathering line utilizing at least one demand print system.

### BACKGROUND ART

Books and other printed materials typically comprise a series of signatures that have been bound together. Each signature consists of one or more printed pages, wherein the signatures are gathered on a gathering or binding line in a particular order, and are then stitched or glued together to form the book.

A known saddle-stitch gathering line typically includes a plurality of packer boxes positioned along a gathering conveyor in the form of a chain, wherein each packer box or a selected set of packer boxes delivers printed signatures in order onto chain spaces of the gathering conveyor. The gathered signatures are then bound, trimmed, bundled, and shipped using well known methods. More detailed explanations of the gathering line process can be found in Magee et al., U.S. Pat. No. 5,458,323 and Dooley, U.S. Pat. No. 6,257,566, owned by the assignee of the present application and the disclosures of which are incorporated herein by reference.

Using computer control systems, it is now possible to customize a book or a magazine in order to target a particular demographic group. This is typically accomplished by selectively enabling and disabling selected packer boxes along a binding line so that a signature designed to appeal to the targeted demographic group is inserted into the book at a designated location.

It is also possible to customize the finished book further by customizing or personalizing one or more of the signatures. This can be accomplished using an apparatus for controlling an electronic press to print fixed and variable information. The apparatus is described in detail in Warmus et al., U.S. Pat. No. 6,327,599, the disclosure of which is incorporated herein by reference.

Wong, U.S. Reissue Pat. No. 32,690, owned by the assignee of the present invention, discloses a collating and binding system for producing customized versions of books. The system includes means for detecting a defective book, means responsive to the detecting means for rejecting the defective book, and means for reordering the rejected book at a point that optimizes postal discounts

Abram et al., U.S. Pat. No. 3,899,165 and Riley et al., U.S. Pat. No. 4,121,818, both owned by the assignee of the present invention, disclose signature collating and binding systems. Each system includes a plurality of feeders that selectively feed signatures to a binding line in order to collate the contents of a book. Thereafter, the collated contents are driven past a book thickness caliper and possibly a thin book reject station before reaching a stitcher and a trimmer, wherein the contents are stitched and trimmed to form a book.

The Dooley '566 patent noted above, discloses a binding line including a gathering conveyor and a plurality of packer boxes positioned along the gathering conveyor, wherein each of the packer boxes is adapted to deliver signatures to the conveyor. The binding line further includes a feeder system operatively associated with at least one of the packer boxes, wherein the feeder system includes a feed conveyor and a plurality of feeder boxes. Each of the feeder boxes is adapted to deliver a selected signature to an associated packer box. The binding line further includes a primary controller for activating a selected set of the packer boxes, thereby delivering a selected set of signatures to the gathering conveyor.

Warmus et al., U.S. Pat. No. 6,327,599, also owned by the assignee of the present invention, discloses an apparatus and method for controlling an electronic press to print fixed and variable information. The apparatus creates stripped master page data sets representing pages having only master or fixed information thereon and stripped variable page data sets. Variable information is transferred from a database to the variable data sets wherein the variable data sets represent pages having only variable information thereon. Thereafter, the master and variable page files, along with a press command file including instructions for combining the master and variable data sets, are sent to the electronic press for printing.

### SUMMARY OF THE INVENTION

According to one aspect of the present invention, a book production apparatus comprises a gathering line operable during a production sequence and a demand printer for producing printed pages. The book production apparatus further includes a feeding device operable to feed the printed pages to the gathering line and a controller that coordinates operation of the gathering line, the demand printer, and the feeding device during the production sequence to produce books.

According to another aspect of the present invention, a book production apparatus includes a gathering line operable during a production sequence and a demand printer for producing customized pages. The apparatus further includes a feeding device operable to feed the customized pages to the gathering line and a controller that coordinates operation of the gathering line, the demand printer, and the feeding device during the production sequence to produce customized books.

According to yet another aspect of the present invention, a method of producing books comprises the step of supplying a gathering line, a plurality of demand printers, and a plurality of feeding devices. The method further includes the step of coordinating simultaneous operation of the gathering line, the demand printers, and the feeding devices during a production sequence to produce the books.

Other aspects and advantages of the present invention will become apparent upon consideration of the following detailed description and the attached drawings, in which like elements are assigned like reference numerals.

### BRIEF DESCRIPTION OF THE DRAWINGS

FIG. 1 is a block diagram illustrating a first embodiment of a book production apparatus of the present invention;

FIG. 2 is a block diagram illustrating one of the demand print systems of FIG. 1 in greater detail;

FIG. 3 is a block diagram of a first embodiment of one of the feeding devices of FIG. 1;

FIG. 4 is a block diagram of a second embodiment of a feeding device of FIG. 1;

FIG. 5 is a block diagram of a third embodiment of a feeding device of FIG. 1;

FIG. 6 is a block diagram of a fourth embodiment of a feeding device of FIG. 1;

FIG. 7 is a block diagram of the packer box of FIGS. 4 or 6;

FIG. 8 is a block diagram of a first system for controlling demand printers according to the present invention;

FIG. 9 is a block diagram of a second system for controlling demand printers according to the present invention;

FIG. 10 is a block diagram illustrating a second embodiment of a book production apparatus of the present invention;

FIG. 11 is a block diagram illustrating a third embodiment of a book production apparatus of the present invention;

FIG. 12 is a block diagram illustrating a fourth embodiment of a book production apparatus of the present invention;

FIG. 13 is a block diagram illustrating a fifth embodiment of a book production apparatus of the present invention; and

FIG. 14 is a block diagram of a sixth embodiment of a book production apparatus of the present invention.

### DESCRIPTION OF THE PREFERRED EMBODIMENTS

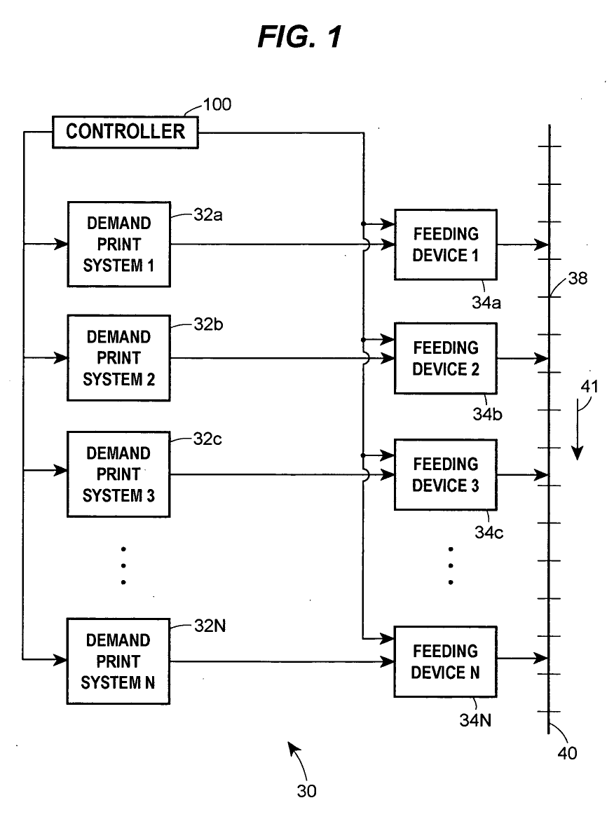

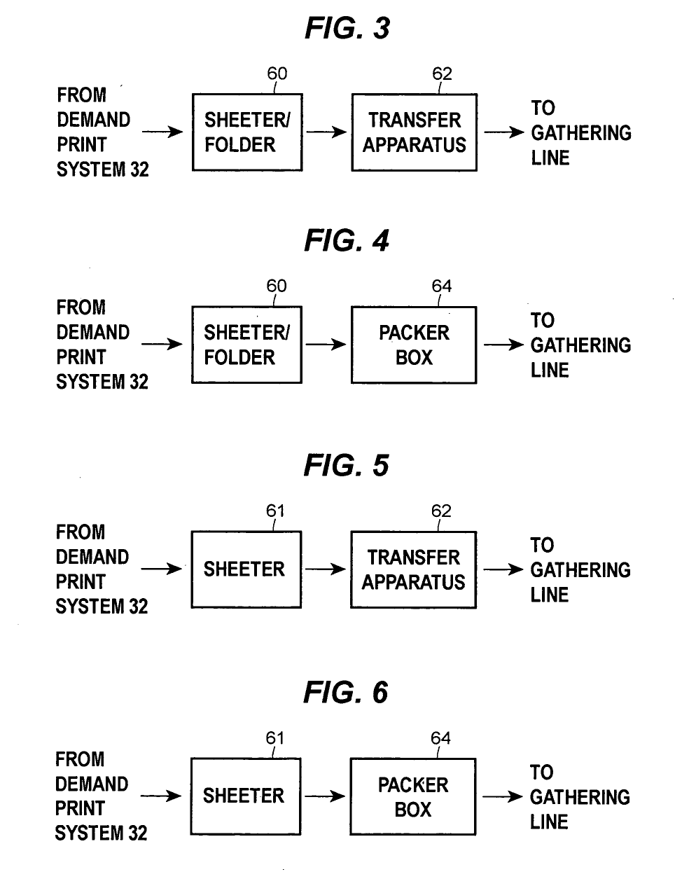

Referring now to the drawings, a first embodiment of a book production apparatus 30, as seen in FIG. 1, includes a plurality of demand print systems 32a, 32b, 32c . . . 32N each of which prints on continuous webs and feeds the webs to an associated feeding device 34a, 34b, 34c . . . 34N. The feeding devices 34a, 34b, 34c . . . 34N may include a sheeter/folder (FIGS. 3 and 4) that forms the webs into folded signatures. Still further, each feeding device 34a, 34b, 34c . . . 34N feeds the associated signature to a chain space 38 of a gathering 40 of the type commonly employed in the art. The gathering line 40 includes a gathering chain or conveyor that is moveable past the feeding devices 34a, 34b, 34c . . . 34nN. The gathering conveyor includes a plurality of chain spaces 38 separated from one another by pusher pins, wherein each chain space is adapted to receive signatures from at least some of the feeding devices 34a, 34b, 34c . . . 34N in order as the chain spaces travel in the direction noted by the arrow 41. The embodiments herein are disclosed in connection with a saddle stitch gathering device, as described in detail above. Other types of gathering devices may be employed in the present invention, including but not limited to, flat or patent binding systems wherein signatures are loaded into a conveyor in a flat condition.

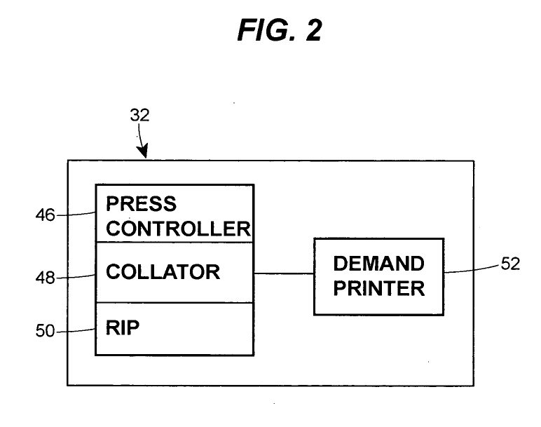

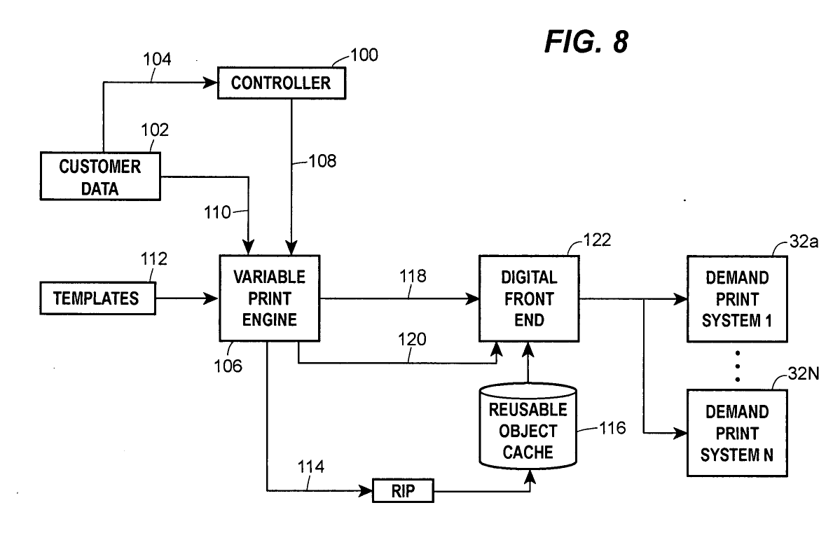

FIG. 2 illustrates a single demand print system 32a, 32b, 32c . . . 32N it being understood that the other demand print systems 32a, 32b, 32c . . . 32N may be (but need not be) identical thereto. The demand print system 32a, 32b, 32c . . . 32N includes a press controller 46, a collator 48, and a raster image processor (RIP) 50 that are operable in response to press commands generated by a control system (described in greater detail hereinafter in connection with FIG. 8). The collator 48 is an electronic device for storing raster image processed files (i.e., bitmap files or symbolic printer control language files) and delivering selected files to a demand printer 52 in real time, such that the demand printer 52 can run at full speed while processing and printing unique page data for each book. The collator 48 includes memory in the form of mass storage drives and physical memory and collates the bitmap page files. If desired, the collator 48 and/or RIP 50 may comprise a part of the press controller 46. The press controller 46 instructs the collator 48 to send the page files to the demand printer 52. The demand print system 32a, 32b, 32c . . . 32N may comprise the PrintStreamer system, manufactured and marketed by Barco Graphics of Belgium, while the demand printer 52 may comprise the Xeikon DCP-1 digital color press noted above. It should be noted that a different print system and/or demand printer may alternatively be used, such as the Indigo printer manufactured by HP/Indigo if desired.

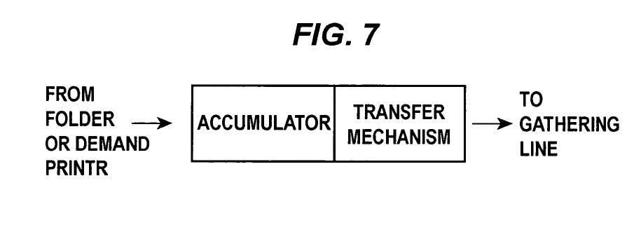

Several embodiments of the feeding device 34a, 34b, 34c . . . 34N of the present invention are depicted in FIGS. 3-6. In the embodiment of FIG. 3, a feeding device 34a, 34b, 34c . . . 34N may include a sheeter/folder 60 that receives a continuous printed web from a demand print system 32a, 32b, 32c . . . 32N, and cuts and folds the web appropriately. Thereafter, the printed, cut, and folded web in the form of a signature is transferred via a transfer apparatus 62 adjacent the gathering line 40 to the gathering line 40 for addition to a book. In FIG. 4, a packer box 64 replaces the transfer apparatus 62 of FIG. 3. Referring also to FIG. 7, when the packer box 64 receives the folded signatures from the sheeter/folder 60, the signatures are stacked in an accumulator 66. As the signatures are needed, the signatures are transferred from the accumulator 66 in a last-in-first-out (LIFO) order (or any other order, such as FIFO) by way of a transfer mechanism 68 in the form of a gripper or vacuum to a chain space 38 of the gathering line 40. The embodiments of FIGS. 3 and 4 may be used for applications where signatures or flats are prefolded prior to assembly into a book.

Optionally, the embodiments of FIGS. 5 and 6 may be used for applications where signatures are not prefolded, but wherein it is still necessary to convert the web into sheets by way of a sheeter 61. In this case, the feeding device 34a, 34b, 34c . . . 34N includes only a sheeter 61 and either a transfer apparatus 62 or a packer box 64, described above with respect to FIGS. 3 and 4.

Referring next to FIG. 8, a controller 100, preferably a programmable logic controller or a microprocessor, controls the operation of the demand print systems 32a, 32b, 32c . . . 32N and the operation of the feeding devices 34a, 34b, 34c . . . 34N of the gathering line 40. The controller 100 receives customer data 102 in the form of a mail record sequencing file over one or more lines 104, wherein the sequencing file noted by one or more lines 104 includes the order in which the books will be created, preferably in postal sort order as discussed in detail in Dreyer et al. U.S. Pat. No. 5,987,461, the disclosure of which is hereby incorporated by reference herein. The controller 100 signals to a variable print engine 106 that a certain book is to be produced by sending data in the form of a record number identifying a particular book to be produced and a destination number over one or more lines 108 from the sequencing file represented by one or more lines 104 to the variable print engine 106. The destination number identifies a particular demand print system 32a, 32b, 32c . . . 32N to be used to produce the book as noted in detail hereinafter.

As part of this operation, the variable print engine 106 receives template files having master (or fixed) information and variable information and separates the master and variable information into separate data streams. The variable print engine may comprise the system disclosed in the Warmus et al. '599 patent incorporated by reference herein, particularly as described in FIG. 5 thereof. The master information (also referred to herein as “reusable components”) is sent over one or more lines 114 and is optionally processed by a master image processor (RIP) 115 and stored in a cache 116 for later use. If the RIP 115 is used, the reusable components are stored in bitmap form in the cache 116 and do not need to be re-ripped at a later time; otherwise, the reusable components are stored in a page description language form, such as Postscript®, and are ripped at a later time. The variable print engine also sends the variable information (also referred to as “variable components” herein) over one or more lines 118 and a bookticket file over one or more lines 120 to a digital front end 122, wherein the bookticket file specifies how the reusable components and variable components are to be merged during printing. The digital front end 122 takes the reusable components, the variable components, and the bookticket file and sends them to the appropriate demand print system 32a, 32b, 32c . . . 32N as identified by the destination file. When the demand print system 32a, 32b, 32c . . . 32N receives the appropriate information, it processes the request, and prints the appropriate continuous printed web. The printed web is then handled as noted in connection with FIGS. 1, 10, 11, 12, 13, or 14.

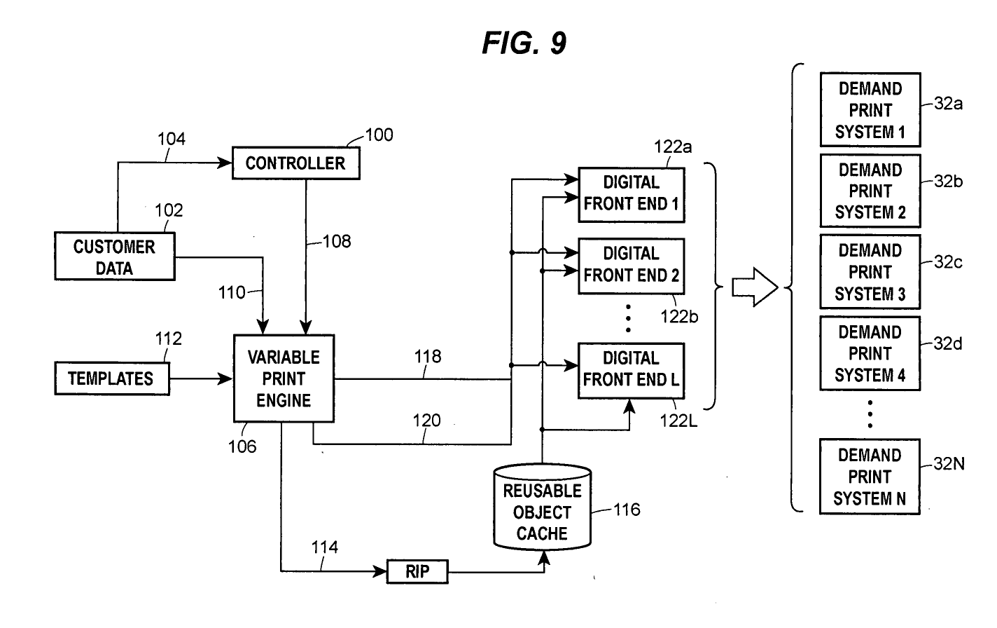

As seen in FIG. 8, there may be one digital front end 122 that communicates with plural demand print systems 32a, 32b, 32c . . . 32N. Optionally, as seen in FIG. 9, there may be several digital front ends 122a, 122b . . . 122L wherein each front end 122a, 122b . . . 122L communicates with a single or multiple demand print systems 32a, 32b, 32c . . . 32N.

The controller 100 as seen in FIGS. 1 and 10-14 not only controls the operation of the demand print systems 32a, 32b, 32c . . . 32N but also controls the operation of the feeding devices 32a, 32b, 32c . . . 32N of the gathering line 40 (referring to FIG. 1). As a book is being produced along the gathering line 40, the controller 100 sends control signals to selected feeding devices 32a, 32b, 32c . . . 32N to direct the selected feeding devices 32a, 32b, 32c . . . 32N to feed a signature at appropriate times relative to the operation of the gathering line 40. The controller may be responsive to one or more feedback devices and/or sensors (not shown) that detect the position of the gathering line 40, whether a signature has been properly fed to the conveyor 40, a caliper that discloses whether a book is of the correct thickness, etc. The book production apparatus of the present invention employs a selective gathering system, wherein the plurality of feeding devices 32a, 32b, 32c . . . 32N selectively feed signatures to the gathering line 40 in order to collate the contents of a book. As should be evident, a book may include fewer signatures therein than there are feeding devices 32a, 32b, 32c . . . 32N.

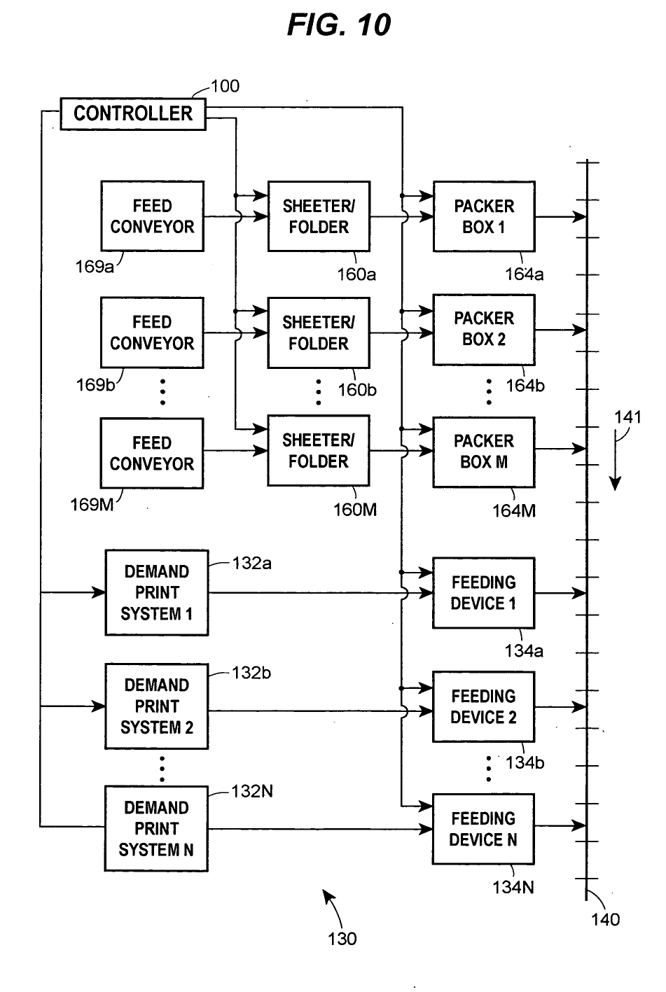

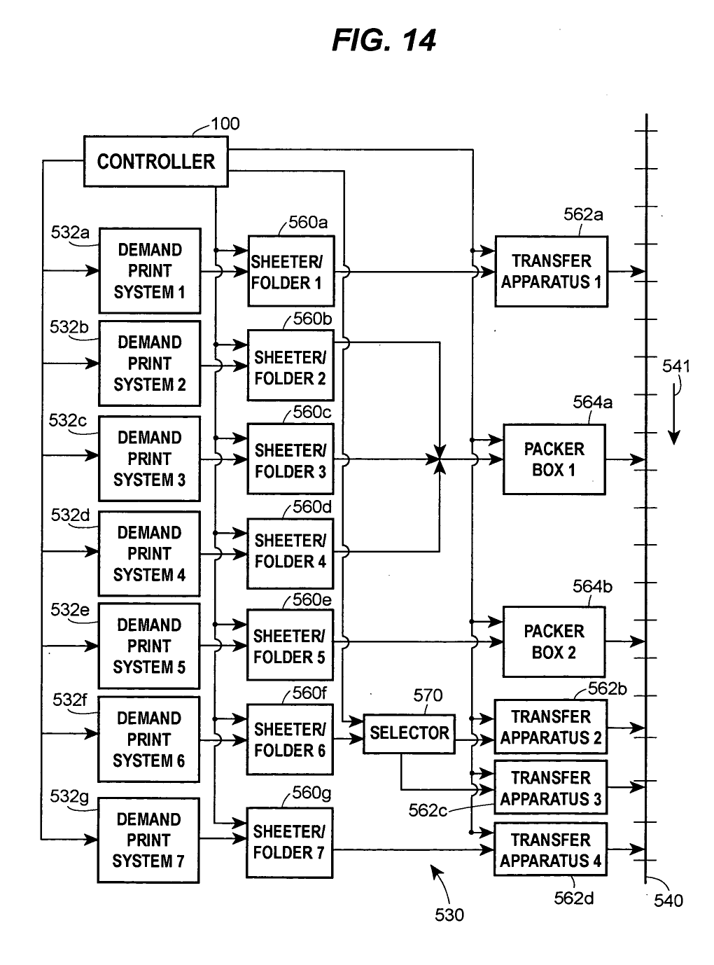

Additionally, the controller 100 controls the operation of the sheeter/folder combinations as referenced in FIGS. 10 and 14 or the sheeter/folder combinations that are included as part of the feeding devices of FIGS. 1 and 10-13. The controller 100 monitors for any jams in the sheeter/folder, missing signatures, improper multiple signatures, misfeeds, incorrectly folded signatures, and, possibly, other errors. The controller 100 also directs the sheeter/folder combinations how to cut and/or fold the printed webs. As should be evident to one of ordinary skill in the art, it is possible to utilize a sheeter with multiple folders to produce any type of signature style, such as a gatefold, a quarter fold, a rollout gatefold, an accordion fold, a z-fold, an envelope fold, a letter fold, or a French fold.

The controller 100 controls production timing and further determines the content of each signature. Production timing is based on getting all the component parts of a book together into one chain space of the gathering line. For example, the book production apparatus of the present invention can coordinate a name on a catalog order blank included in a book with a name on a cover of the book, and can also coordinate the name on the catalog order blank with the variable page content of such book. This timing is based on knowing where the demand print systems and feeding devices are located in relation to each other and is usually measured in inches so that the measurement is speed independent. The content of each signature is based on the customer data 102. The mail sequencing file transmitted over the one or more lines 104 in FIG. 8 determines the timing of the variable print engine 106. There may be additional time required to print one or more signatures if the customer data 102 are complex. In such a case, the controller 100 orders a variable signature earlier in the production sequence so that the signature can be produced in time to meet the other book components at the proper place on the gathering line.

Selective gathering systems of this type are disclosed in the Magee et al. '323, Dooley '566, and Warmus '599 patents noted above, and in the Abram et al. '165 and Riley et al. '818 patents and the Wong '690 reissue patent identified above, the disclosures of which are incorporated by reference herein. The selective gathering system may further include features that permit a defective book to be reordered so as to optimize postal discounts, such as described in the Wong '690 reissue patent, or as disclosed in Dreyer et al. U.S. Pat. No. 6,246,993, owned by the assignee of the present application and the disclosures of which are incorporated by reference herein. Still further the system described herein may incorporate any of the features disclosed in the following patents owned by the assignee of the present application, the disclosures of which are hereby incorporated by reference herein: Warmus et al. U.S. Pat. No. 6,446,108; Warmus et al. U.S. Pat. No. 6,332,149; Warmus et al. U.S. Pat. No. 6,205,452; Shively U.S. Pat. No. 6,175,846; Dreyer et al. U.S. Pat. No. 6,088,710; Dreyer et al. U.S. Pat. No. 5,987,461; Warmus et al. U.S. Pat. No. 5,963,968; and Shively U.S. Pat. No. 5,870,766.

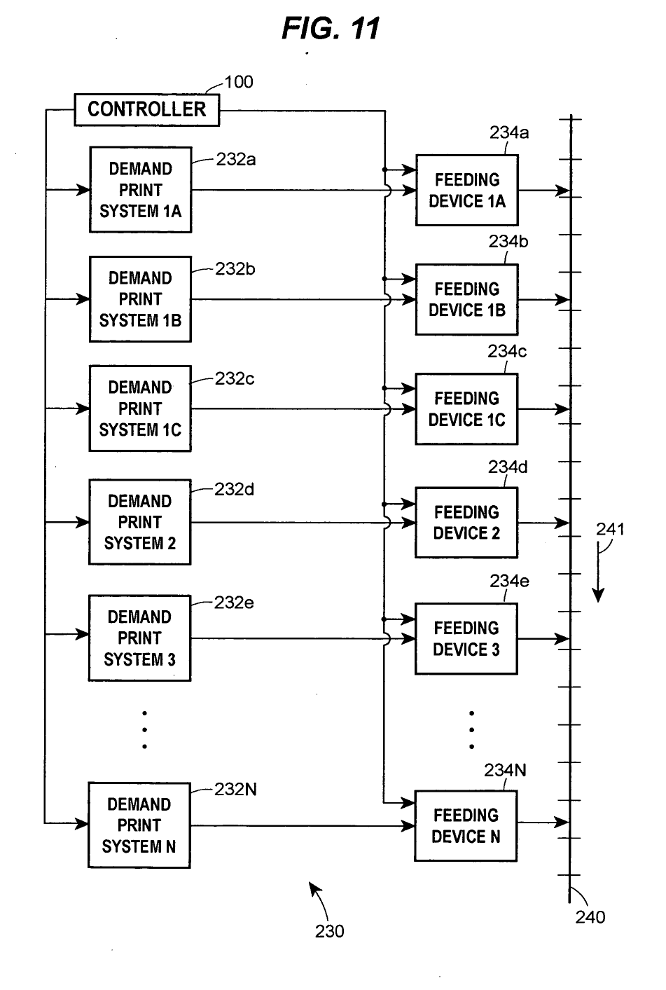

In another embodiment of the present invention as seen in FIG. 10, a book production apparatus 130 includes a plurality of demand print systems 132a, 132b . . . 132N, which print continuous printed webs and feed each web to an associated feeding device 134a, 134b . . . 134N respectively, as described in detail above with reference to FIGS. 3-6. Additionally, the apparatus 130 includes a plurality of packer boxes 164a, 164b . . . 164M. Each of the feeding devices 134a, 134b . . . 134N and packer boxes 164a, 164b . . . 164M feeds an associated signature on demand to the gathering line 140 of the type commonly employed in the art. The structure of the packer boxes 164a, 164b . . . 164M is described in detail with respect to FIG. 7. The packer boxes 164a, 164b . . . 164M are fed signatures from one or more feed conveyors 169a, 169b . . . 169M as described in detail in the Dooley, '566 patent. Therefore, with respect to the packer boxes 164a, 164b . . . 164M, the signatures are printed, cut, and folded elsewhere and transported to the packer boxes 164a, 164b . . . 164M. On the other hand, the feeding devices 134a, 134b . . . 134N of FIG. 10 are fed continuous printed webs directly from a demand print system 132a, 132b . . . 132N that prints the appropriate webs on demand and in-line. As should be evident, each feed conveyer 169a, 169b . . . 169M may feed to a single associated packer box 164a, 164b . . . 164M, respectively (as seen in FIG. 10), or a feed conveyor 169 may feed to plural packer boxes 164. Also, the sequence of the packer boxes 164 and the feeding devices 134 may be different from that shown in FIG. 10. For example, as the gathering line 140 moves downwardly as seen in FIG. 10, the gathering line 140 may first encounter the packer box 164a, then the feeding device 134a, the packer box 164b, the feeding device 134b, and so on until the line 140 encounters the packer box 164M and the feeding device 134N. Obviously, any other sequence could instead be utilized. Also, the numbers M and N may be different or equal and can have any integer value(s). Optionally, as seen in FIG. 11, another embodiment of a book production apparatus 130 may include several demand print system 232a, 232b, 232c, 232d, 232e . . . 232N/feeding device 234a, 234b, 234c, 234d, 234e . . . 234N combinations that create different versions of a single signature. Demand print system 232a, 232b, 232c/feeding device 234a, 234b, 234c combinations create different versions of a single signature, such that a book receives a signature from only one (or none) of these demand print system 232a, 232b, 232c, 232d, 232e . . . 232N/feeding device 234a, 234b, 234c, 234d, 234e . . . 234N combinations. Any, all or none of the signatures of each book may be produced in this manner.

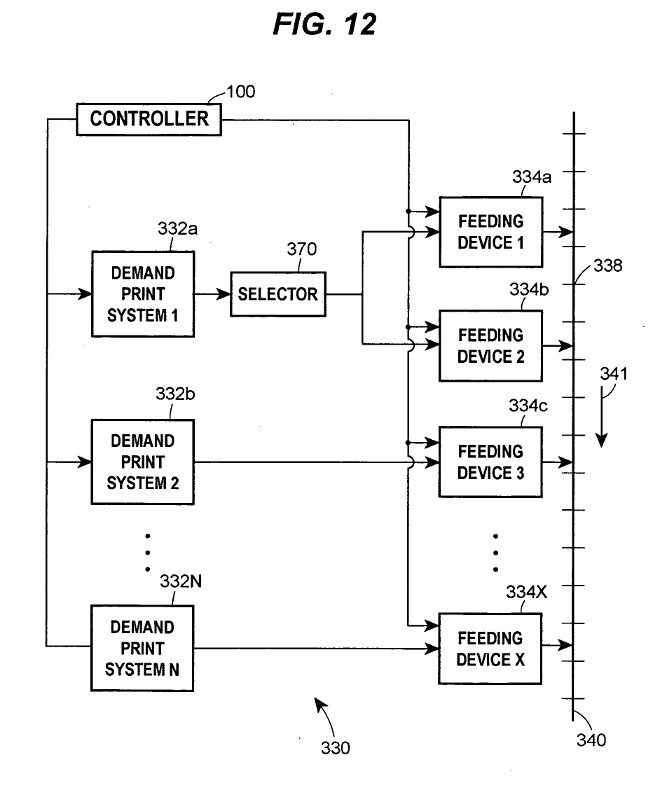

A selector 370 may be added between any demand print system 332a, 332b . . . 332N and any number of feeding devices 334a, 334b, 334c . . . 334X of a book production apparatus 330. As seen in FIG. 12, a single selector 370 is disposed between the first demand print system 332 and the first and second feeding devices 334a, 334b. The selector 370 performs the function of feeding continuous printed webs to a selected one or both of the first feeding device 334a and the second feeding device 334b and thus to one or more associated chain spaces 338 of a gathering line 340. Although the selector 370 is depicted in FIG. 12 as only feeding two feeding devices 334a, 334b, any number of feeding devices 334a, 334b, 334c . . . 334X may be so supplied. Optionally, any number of selectors 370 may be employed in the book production apparatus 330 to control the flow of webs to the feeding devices 334a, 334b, 334c . . . 334X. Each selector 370 is controlled by the controller 100.

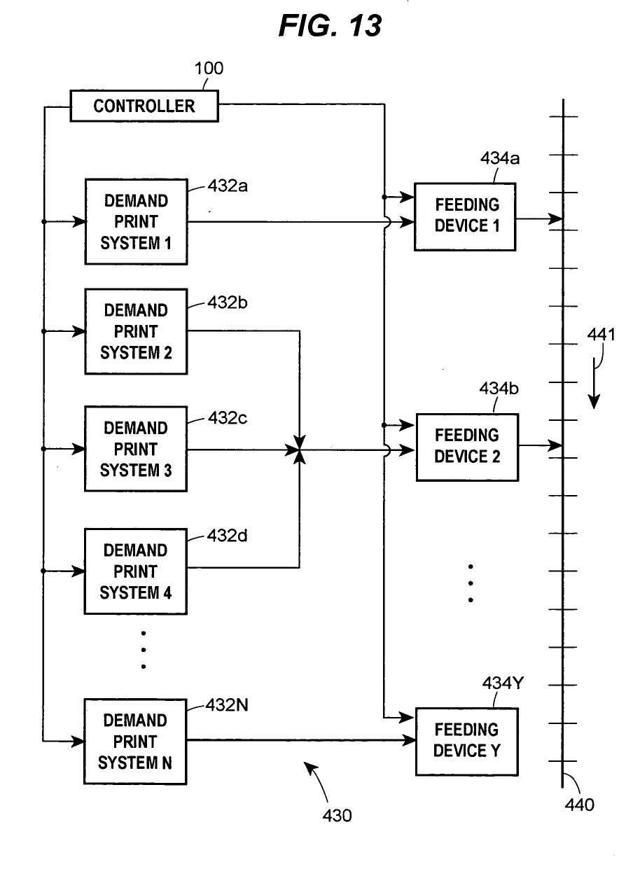

Still another embodiment of a book production apparatus 430 is depicted in FIG. 13. The book production apparatus 430 includes a plurality of demand print systems 432a, 432b, 432c, 432d . . . 432N that print continuous webs and feed such webs to a plurality of associated feeding devices 434a, 434b . . . 434Y, wherein the feeding devices 434a, 434b . . . 434Y may be similar or identical to the devices discussed in relation with FIGS. 3-6. Two or more demand print systems 432a, 432b, 432c, 432d . . . 432N (e.g. devices 432b-432d as shown) may feed webs to a single feeding device 434 (434b as shown) of the gathering line 440. Any number of demand print systems 432 may be directed to feed webs to a single or multiple feeding devices 434. In addition, this setup can be employed for any number of the feeding devices 434. For example, three demand print systems 432 may feed to a first feeding device 434, one demand print system 432 may feed to a second feeding device 434, and two demand print systems 432 may feed to a third feeding device 434.

As depicted in FIG. 14, any or all of the options of the previous embodiments may be included in a book production apparatus 530. For example, the apparatus 530 includes multiple demand print systems 532a, 532e, 532g that print on continuous webs and feed the printed webs to associated sheeter/folders 560a, 560e, 560g. The sheeter/folders 560a, 560e, 560g convert the printed webs into cut sheets and fold the sheets to form signatures. The signatures are delivered to an associated transfer apparatus 562a, 562d or packer box 564a that transfer the folded signatures to the gathering line 540. The apparatus 530 additionally includes demand print systems 532b-532d that print on continuous webs and feed the webs to associated sheeter/folders 560 wherein folded webs are cut and folded and the associated signatures are all sent to a single packer box 564a that transfers the folded signatures to the gathering line 540.

Still further, the apparatus 530 includes a demand print system 532f that prints continuous webs, feeds the webs to an associated sheeter/folder 560f wherein the webs are cut and folded, and a selector 570 that determines whether the cut and folded web in the form of a signature is to be fed to a first or a second transfer apparatus 562b or 562c.

Optionally, a flat or patent binding system may include an apparatus for feeding patent covers. Such apparatus may be disposed after the gathering line. Once the appropriate signatures are gathered by the gathering line, the signatures are sawed and glued to bind the signatures into book form. Before the glue is dry, a flat patent cover may be fed to the book through means known in the art, wherein a center portion of the patent cover is adhered to the glue and the patent cover is wrapped around a front and a back of the book. Thereafter, the book with patent cover may be trimmed.

Numerous modifications will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

1. Book production apparatus, comprising:
a gathering line operable during a production sequence;
a demand printer for producing printed pages;
a feeding device operable to feed the printed pages to the gathering line; and
a controller that coordinates operation of the gathering line, the demand printer, and the feeding device during the production sequence to produce books.

2. The book production apparatus of claim 1, wherein the controller is coupled to a control interface that controls the demand printer.

3. The book production apparatus of claim 2, wherein the control interface is responsive to a template file having fixed and variable information.

4. The book production apparatus of claim 3, wherein the control interface includes a processing apparatus operable to separate the fixed and variable information into separate fixed and variable data streams.

5. The book production apparatus of claim 4, wherein the separate fixed and variable data streams are provided to a collator/raster image processor together with a database and a press command file.

6. The book production apparatus of claim 1, wherein the feeding device includes a folder for folding the printed pages.

7. The book production apparatus of claim 6, wherein the feeding device further includes a transfer apparatus that transfers the folded printed page to the gathering line.

8. The book production apparatus of claim 1, wherein the feeding device comprises a packer box that receives the printed pages.

9. The book production apparatus of claim 8, wherein the packer box includes a transfer mechanism that transfers printed pages to the gathering line.

10. The book production apparatus of claim 9, wherein the feeding device further includes a folder for folding the printed pages.

11. The book production apparatus of claim 10, wherein the feeding device further includes a transfer apparatus that transfers the folded printed page to the packer box.

12. The book production apparatus of claim 1, further including an additional demand printer that prints fulfillment pieces during the production sequence wherein the fulfillment pieces are delivered to the gathering line.

13. The book production apparatus of claim 1, wherein the demand printer overprints on a preprinted web of paper.

14. The book production apparatus of claim 1, further including at least one additional demand printer and feeding device and wherein the controller synchronizes the operation of the gathering line, all of the demand printers, and all of the feeding devices during the production sequence to produce books.

15. The book production apparatus of claim 14, wherein different demand printers print different pages of the books.

16. The book production apparatus of claim 14, wherein different demand printers print different versions of the same page of the books.

17. The book production apparatus of claim 14, wherein each feeding device includes a folder for folding pages.

18. The book production apparatus of claim 17, wherein each feeding device includes a transfer apparatus that transfers the folded printed pages to the gathering line.

19. The book production apparatus of claim 17, wherein each feeding device further includes a packer box that receives the folded printed pages and transfers them to the gathering line.

20. The book production apparatus of claim 14, wherein each feeding device includes a transfer apparatus that transfers the folded printed pages to the gathering line.

21. The book production apparatus of claim 14, wherein each feeding device includes a packer box that receives the folded printed pages and transfers them to the gathering line.

22. The book production apparatus of claim 14, wherein each different feeding device of the book production apparatus may include different components.

23. Book production apparatus, comprising:
a gathering line operable during a production sequence;
a demand printer for producing customized pages;
a feeding device operable to feed the customized pages to the gathering line; and
a controller that coordinates operation of the gathering line, the demand printer, and the feeding device during the production sequence to produce customized books.

24. The book production apparatus of claim 23, wherein the controller is coupled to a control interface that controls the demand printer.

25. The book production apparatus of claim 24, wherein the control interface is responsive to a template file having fixed and variable information.

26. The book production apparatus of claim 25, wherein the control interface includes a processing apparatus operable to separate the fixed and variable information into separate fixed and variable data streams.

27. The book production apparatus of claim 26, wherein the separate fixed and variable data streams are provided to a collator/raster image processor together with a database and a press command file.

28. The book production apparatus of claim 23, wherein the feeding device includes a folder for folding the customized pages.

29. The book production apparatus of claim 28, wherein the feeding device further includes a transfer apparatus that transfers the folded customized page to the gathering line.

30. The book production apparatus of claim 23, wherein the feeding device comprises a packer box that receives the customized pages.

31. The book production apparatus of claim 30, wherein the packer box includes a transfer mechanism that transfers customized pages to the gathering line.

32. The book production apparatus of claim 31, wherein the feeding device further includes a folder for folding the customized pages.

33. The book production apparatus of claim 32, wherein the feeding device further includes a transfer apparatus that transfers the folded customized page to the packer box.

34. The book production apparatus of claim 33, further including an additional demand printer that prints fulfillment pieces during the production sequence wherein the fulfillment pieces are delivered to the gathering line.

35. The book production apparatus of claim 23, wherein the demand printer overprints on a preprinted web of paper.

36. A method of producing books, the method comprising the steps of:
supplying a gathering line, a plurality of demand printers, and a plurality of feeding devices; and
coordinating simultaneous operation of the gathering line, the demand printers, and the feeding devices during a production sequence to produce the books.

37. The method of claim 36, wherein the step of coordinating includes the step of operating a controller coupled to the gathering line, the demand printers, and the feeding devices.

38. The method of claim 37, wherein each demand printer is responsive to a printer control unit and the step of operating includes the step of transmitting commands to the printer control units.

39. The method of claim 38, wherein each printer control unit includes a processing apparatus and further includes the step of separating master and variable data streams in the processing apparatus.

40. The method of claim 39, wherein each printer control unit further includes a collator/raster image processor and includes the further step of providing the master and variable data streams, a database, and a press command file to the collator/raster image processor.

41. The method of claim 36, further including the step of folding pages printed by the demand printers prior to delivery of the pages to the gathering line.

42. The method of claim 36, wherein each feeding device includes a packer box and wherein the step of coordinating includes the step of operating the packer box in synchronism with the gathering line.
